(19) United States
(12) Patent Application Publication
(10) Pub. No.: US 2024/0262537 A1
(43) Pub. Date: Aug. 8, 2024

(54) Rotational Energy Based Propulsion System

(71) Applicant: Carsten James Quinlan, Woodbury, MN (US)

(72) Inventor: Carsten James Quinlan, Woodbury, MN (US)

(21) Appl. No.: 18/163,254

(22) Filed: Feb. 1, 2023

(51) Int. Cl. B64G 1/40; F03G 3/08; F03G 7/10

(52) U.S. Cl. CPC B64G 1/409; B64C 39/001; F03G 3/08; F03G 7/125

(57) ABSTRACT

This application is for specifying the basic physics behind a propulsion system based upon using rotational energy in place of kinetic energy to induce a new kind of orbit that resembles levitation. Evidence from an experiment is presented showing that the author was able to measure a small upwards force on a spinning gyroscope in a vacuum to justify the physics. A plan for building a flying craft using this mechanism is shown where the upwards force opposing gravity is from the centrifugal forces of rapidly rotating flywheels that rotate at speeds comparable to orbital velocity speeds. Rotational energy can be translated into kinetic energy by selectively exposing small portions of the spinning flywheels to the atmosphere, which allows for the craft to accelerate in any direction.

### REFERENCE TO RELATED APPLICATIONS

Provisional Patent Application No. 63/306,479 Filed on Feb. 2, 2022.

### BACKGROUND OF THE INVENTION

This is an Aeronautical Propulsion Mechanism. It is a new type of propulsion mechanism, and not an incremental improvement upon either rocket or jet or propeller propulsion mechanisms.

Instead of relying upon chemical energy stored as fuel to be burned, the energy is stored in flywheels that are rotating extremely quickly (much more rapidly than their normal use as energy storage devices). When these flywheels are rotated so fast that they are moving at speeds similar to that of orbiting satellites, then there will be a significant upwards force from the centrifugal effect with respect to the Earth.

This invention is only possible with exotic materials that have extremely high tensile strength to density ratios such as Carbon Nanotubes. Flywheels constructed out of other materials below this threshold will be torn apart by centrifugal forces before attaining enough energy to achieve a significant lift force.

The inventor was able to verify the existence of this lift force by carefully measuring the weight of a rapidly spinning gyroscope in a vacuum chamber. When rapidly spinning, the weight of the gyroscope was less than when the gyroscope was not spinning, and this difference was approximately the same size as what was predicted by the physics equations. The measured difference was significantly larger than what was predicted, but the inventor lacked resources to further investigate this discrepancy.

Therefore the physics and engineering related to this invention is aeronautical engineering, flywheel engineering, materials engineering, physics of rotating bodies, and the physics of orbital mechanics.

### SUMMARY OF THE INVENTION

After investigating the common observations surrounding the “flying saucer” UAPs, I was able to find some physics equations that could explain their motion. The physics for this propulsion system is an extension of orbital dynamics. However, instead of an object having enough kinetic energy to remain in orbit, the object instead has this same amount of energy stored as rotational energy in at least one rapidly spinning flywheel. Just as a normal satellite experiences centrifugal forces that counterbalance gravity, the rapidly moving parts of the flywheel also experience centrifugal force away from the earth to balance gravity. The same laws of conservation of angular momentum and energy imply an orbital path that looks like levitation. The physics is based on a balance between the gravitational attraction of the craft, and centrifugal repulsion from the rapidly spinning portion of the craft.

### OBJECT OF THE INVENTION

One major benefit of this strategy is that the orbit can be sheltered from interaction with the atmosphere. Controlled bursts of allowing drag interactions between the atmosphere and the rapidly rotating flywheel provide thrust in almost any direction. This allows the craft to trade between kinetic energy and rotational energy. It will also allow for aircraft to hover silently without expending energy and accelerate in any direction rapidly.

This invention will provide a far more efficient mechanism for launching payloads into space. The rocket equation and the drag from the atmosphere makes ascending into space extremely expensive. With this invention it will become far less expensive because rotational energy can be added to (or removed from) the craft without the craft needing to relocate, unlike a rocket.

It could also be used in static structures to provide supporting lift force at high altitudes. This would use the centrifugal forces on the rotating parts to push upwards on the structure, thus providing support without added weight on the structure below.

### BRIEF DESCRIPTION OF FIGURES

FIG. 1 explains the source of repulsive forces between two rotating rings. In the limit that one mass is far larger than the other, the equations simplify.

FIG. 2 shows data collected during our experiment which showed a decrease in the measured weight of a gyroscope while spinning in a vacuum chamber. As the gyroscope slowed down, the weight returned to normal.

FIG. 3 shows the similarity in orbital trajectories between an object in an elliptical orbit and another object with the same amount of rotational energy as the first object's kinetic energy. These trajectories illustrate how an orbit that looks like levitation operates using the same physics as a normal orbit.

FIG. 4 shows the cross-sectional cut through view of a craft with two flywheels spinning in opposite directions (so that total angular momentum is zero), and how this configuration allows the craft to levitate and also accelerate in any direction by opening shutters that result in frictional forces between the flywheels and the atmosphere.

### BEST MODE FOR CARRYING OUT THE INVENTION

The first issue in building the invention is to design a flywheel that can tolerate the extreme rotation velocities required for achieving a new positive force upwards. There is a density to tensile stress ratio requirement that must be met in order to meet these velocities. Currently only the carbon nanotube materials seem to be beyond this threshold, however we anticipate further developments in materials engineering will provide additional options.

The craft requires two flywheels rotating in opposite directions. This neutralizes the total angular momentum, which allows the craft to be rotated. This also allows the rotational velocity of the flywheels to increase or decrease without inducing unwanted rotation of the craft.

The flywheels must be sheltered from the surrounding environment in a vacuum chamber, however there must also be some mechanism for translating the flywheel's rotational energy into kinetic energy in some direction so that the craft can maneuver.

The mechanisms for powering the flywheels and for allowing controlled interaction with the surrounding environment are not developed in this patent.

### DETAILED DESCRIPTION

The first iteration of the invention is simply a rapidly rotating gyroscope on scale, within a vacuum chamber. The purpose of this was to measure the lift force and verify that the physics were correct. This has already been accomplished.

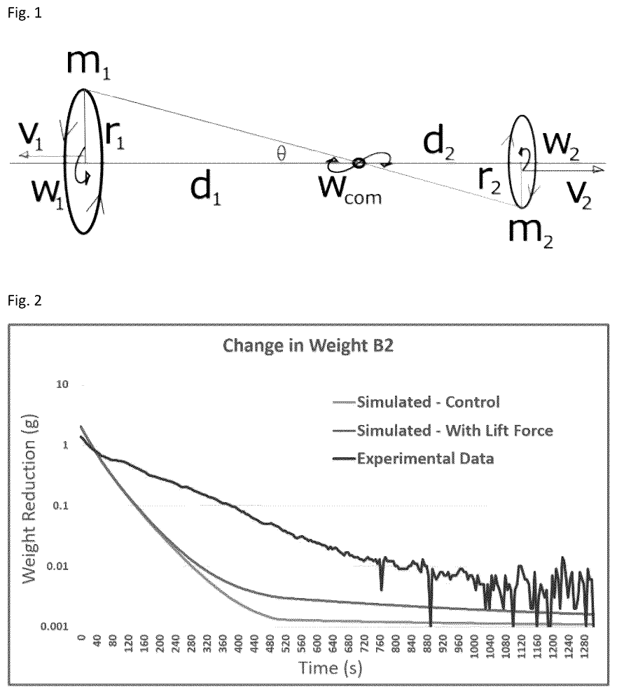

For the following equations refer to FIG. 1 for visual variable definitions. Consider a cylindrically symmetric rigid body of density ρ, at distance z from the center of the dominant body M, and rotating at angular velocity ω about the \hat{z} axis. For an arbitrary differential mass dm in this body, moving at velocity \vec{v}=wr\hat{θ}, the force acting on it is given by the sum of centrifugal and gravitational forces.

$$\vec{dF} = dm [ \frac{{v}^{2}}{r} \hat{r} + ( \frac{{v}^{2}}{z} - \frac{GM}{{z}^{2}} ) \hat{Z} ] , dm = {ρ}_{( r , z )} rd θ dr dz$$

Since the body is cylindrically symmetric, the integral over the radial \hat{r} component evaluates to zero, leaving only the components along the \hat{z} axis.

$$\vec{F} = \int \vec{dF} = 2 π \int \int [ \frac{{ω}^{2} {r}^{2}}{z} - \frac{GM}{{z}^{2}} ] \hat{z} {ρ}_{( r , z )} r dr dz \qquad ( 1 )$$

Consider the case where the overall size of the rigid body is very small compared to r<<R, and R is the object's distance from the origin. Further, assume the body has an internal and external radius of r₁ and r₂, then the density function is:

$${ρ}_{( r , z )} = \{ \begin{matrix}ρ h {δ}_{( z - R )} , & {r}_{1} \leq r \leq {r}_{2} \\ 0 , & else\end{matrix}$$

Where h<<R is the thickness of the body along the \hat{z} axis, and δ_{(z-R)} is the Dirac delta function. Then equation (1) simplifies:

$$\vec{F} = ρ h 2 π {\int }_{{r}_{1}}^{{r}_{2}} [ \frac{{ω}^{2} {r}^{2}}{R} - \frac{GM}{{R}^{2}} ] r dr \hat{z} = ρ h {π [ \frac{{ω}^{2} {r}^{4}}{2 R} - \frac{{GMr}^{2}}{{R}^{2}} ]}_{{r}_{1}}^{{r}_{2}} \hat{z} \qquad ( 2 )$$

$$m = ρ h π ( {r}_{2}^{2} - {r}_{1}^{2} ) , \vec{F} = m [ \frac{{ω}^{2}}{2 R} ( {r}_{2}^{2} + {r}_{1}^{2} ) - \frac{GM}{{R}^{2}} ] \hat{z}$$

The positive term in equation (2) is the lift force. Notice that if we set r₂=r₁ such that all the mass were to be concentrated in a rotating ring, then we can determine the angular velocity required to counteract gravity and produce a stationary orbit.

$$Assume \begin{matrix}\vert \vec{F} \vert = 0 \\ {r}_{2} = {r}_{1} = r\end{matrix} , \frac{{ω}^{2} 2 {r}^{2}}{2 R} = \frac{GM}{{R}^{2}} , ω r = \sqrt{\frac{GM}{R}} \qquad ( 3 )$$

Equation (3) is the same equation for the circular orbital velocity of a point particle about the dominant body M. Therefore, just as a point particle will remain in a stable circular orbit at the orbital velocity, so too will a rotating ring of matter remain in orbit, if it is rotating such that each part of it is moving at the same orbital velocity. For the case where r<<R, this kind of orbit could look like levitation since the ring may seem to remain stationary.

The next iteration of the invention would be to use an industrial flywheel that is already designed to rotate in a vacuum, and have that on a scale appropriate to measure the change in weight as a function of energy stored in the flywheel. The inventor has not had the resources to do this yet.

The first development of a craft that would be maneuverable would be to develop a submersible craft, similar to a submarine, but disk shaped. The additional buoyancy forces would supplement the deficient lift force as we work through the engineering issues of actually building it.

Further iterations of the invention would require building a specialized flywheel out of carbon nanotubes (or other material with sufficient tensile strength to density ratio) that could achieve rotational velocities sufficient to generate a net lift force capable of lifting the craft into the air. Many of the same principles for maneuvering in water would also apply to air. Here is the explanation for why something like carbon nanotubes are required:

For an arbitrary differential volume dV, the total force acting along the z axis is given by the centripetal force and the gravitational force on this element.

$${dF}_{z} = [ {ω}_{E}^{2} z - \frac{{GM}_{E}}{{z}^{2}} ] ρ ( r , z ) d V = [ \frac{{ω}_{D}^{2} {r}^{2}}{z} - \frac{{GM}_{E}}{{z}^{2}} ] ρ ( r , z ) rd θ dr dz$$

Integrating this over the volume of our body will give the general formula for calculating the lift of a cylindrically symmetric rigid body rotating at angular velocity ω about the z axis.

$${F}_{z} = 2 π \int \int [ \frac{{ω}^{2} {r}^{2}}{z} - \frac{{GM}_{E}}{{z}^{2}} ] ρ ( r , z ) r dr dz$$

For the case where our rotating body has a constant density, and an overall height h<<z such that the integral only needs to consider r, and our disk has an internal and external radius of r1, and r2, then the equation can be solved:

$${F}_{z} = 2 π h ρ {\int }_{{r}_{1}}^{{r}_{2}} [ \frac{{ω}^{2} {r}^{2}}{z} - \frac{{GM}_{E}}{{z}^{2}} ] r dr = 2 π h {ρ [ \frac{{ω}^{2} {r}^{4}}{4 z} - \frac{{GM}_{E} {r}^{2}}{2 {z}^{2}} ]}_{{r}_{1}}^{{r}_{2}} = 2 π h ρ ( {r}_{2}^{2} - {r}_{1}^{2} ) [ \frac{{ω}^{2} ( {r}_{2}^{4} - {r}_{1}^{4} )}{4 z ( {r}_{2}^{2} - {r}_{1}^{2} )} - \frac{{GM}_{E}}{2 {z}^{2}} ]$$

$$Note : m = ρ 2 π h ( {r}_{2}^{2} - {r}_{1}^{2} )$$

$$Lift Force : {F}_{z} = m [ \frac{{ω}^{2}}{4 z} ( {r}_{2}^{2} + {r}_{1}^{2} ) - \frac{{GM}_{E}}{2 {z}^{2}} ]$$

$$Condition for Levetation : ω = \sqrt{\frac{2 {GM}_{E}}{z ( {r}_{2}^{2} + {r}_{1}^{2} )}}$$

As an example, lets assume our flywheel is a uniform disk of inner radius of 1 m, and outer radius 2 m, then in order to levitate, the disk will need to spin at:

$$ω = \sqrt{\frac{2 {GM}_{E}}{z ( {r}_{2}^{2} + {r}_{1}^{2} )}} = \sqrt{\frac{2 * 6.67 * {10}^{- 11} * 5.97 * {10}^{24}}{6.37 * {10}^{6} * ( 4 + 1 )}} \frac{rad}{s} = 5. * {10}^{3} \frac{rad}{s}$$

At such a rotation, the rim of our flywheel would be moving at 12,900 m/s. It is extremely fast, and would require some advanced materials to avoid explosion. The maximum hoop stress before exceeding the tensile stress for a uniform disk flywheel is given by:

$$\frac{{σ}_{t}}{ρ} = {r}^{2} {ω}^{2} \approx 1. * {10}^{8} \frac{{m}^{2}}{{s}^{2}}$$

For our 2 m radius flywheel, it would need to be constructed of a material with an ultimate tensile strength to density ratio of less than that maximum value. Graphene is one material that may work, with a maximum tensile strength of 50000 MPa and a density of 1 g/cm³, which works out to

$$Graphene : \frac{{σ}_{t}}{ρ} = \frac{5 * {10}^{10} Pa}{1000 kg / {m}^{3}} = 5 * {10}^{7} \frac{{m}^{2}}{{s}^{2}}$$

This value will not quite be sufficient for levitation; however carbon nanotubes have a theoretical tensile strength of up to 300 GPa with a corresponding density of around 0.55 g/cm³. If we could build our flywheel out of carbon nanotubes material, we have a tensile strength to density ratio of:

$$Theoretical Maximum of Carbon Nanotubes :$$

$$\frac{{σ}_{t}}{ρ} \approx \frac{3 * {10}^{14} Pa}{550 kg / {m}^{3}} = 5.5 * {10}^{11} \frac{{m}^{2}}{{s}^{2}}$$

$$Current Maximum of Carbon Nanotubes :$$

$$\frac{{σ}_{t}}{ρ} \approx \frac{6.3 * {10}^{13} Pa}{550 kg / {m}^{3}} = 1.1 * {10}^{11} \frac{{m}^{2}}{{s}^{2}}$$

These values greatly exceed the minimum required value by a safe margin, so carbon nanotubes would be strong enough to levitate as a flywheel near the Earth's surface.

The final craft would consist of at least two sets of flywheels rotating in opposite directions such that the total angular momentum from each flywheel would sum to zero. The craft would require a mechanism for translating the rotational energy of the wheel into kinetic energy by some sort of interaction with the surrounding fluid or gas. This mechanism would be developed as a separate patent later.

### DETAILED DESCRIPTION OF THE DRAWINGS

FIG. 1

$$Conservation of Momentum :$$

$${\vec{P}}_{0} = 0 = {\vec{P}}_{1} + {\vec{P}}_{2} = {m}_{1} {\vec{v}}_{1} + {m}_{2} {\vec{v}}_{2}$$

$$Conservation of Angular Momentum :$$

$${\vec{L}}_{0} = 0 = {\vec{L}}_{1} + {\vec{L}}_{2} = {m}_{1} {\vec{d}}_{1} \times ( {\vec{ω}}_{1} \times {\vec{r}}_{1} ) + {m}_{2} {\vec{d}}_{2} ( {\vec{ω}}_{2} \times {\vec{r}}_{2} )$$

Now we shall consider the forces acting on both rings. There are two forces, the gravitational force pulling the objects together, and a centrifugal force pushing them apart. The centrifugal term has a component along the z axis, and is given by:

$${\vec{F}}_{cf} = [ {m}_{1} \vert {\vec{d}}_{1} + \vec{{r}_{1}} \vert {{ω}_{com}}^{2} cos θ ] \hat{z} = \frac{{{m}_{1} ( {r}_{1} {ω}_{1} )}^{2}}{\sqrt{{d}_{1}^{2} + {r}_{1}^{2}}} cos θ \hat{z} = {{m}_{1} ( {r}_{1} {ω}_{1} )}^{2} \frac{{d}_{1}}{{d}_{1}^{2} + {r}_{1}^{2}} \hat{Z}$$

$$( using \sqrt{{d}_{1}^{2} + {r}_{1}^{2}} {ω}_{com} = {r}_{1} {ω}_{1} )$$

$${\vec{F}}_{{m}_{1}} = [ - \frac{{Gm}_{1} {m}_{2}}{{( {d}_{1} + {d}_{2} )}^{2}} + {{m}_{1} ( {r}_{1} {ω}_{1} )}^{2} \frac{{d}_{1}}{{d}_{1}^{2} + {r}_{1}^{2}} ] \hat{Z}$$

$${\vec{F}}_{{m}_{2}} = - [ - \frac{{Gm}_{1} {m}_{2}}{{( {d}_{1} + {d}_{2} )}^{2}} + {{m}_{2} ( {r}_{2} {ω}_{2} )}^{2} \frac{{d}_{1}}{{d}_{2}^{2} + {r}_{2}^{2}} ] \hat{Z}$$

There are two important limits for these equations, the first is when the masses and rotations are approximately equal, and the other is when one mass M is far larger than the other mass m. in these equations, R is the distance between the masses to match normal portrayal of the force of gravity. We also assume that R>>r which significantly simplifies the equations. These equations reduce to the normal point mass version when rω=0.

$${lim}_{{{m}_{1} \approx {m}_{2}}_{R ≫ r}} {\vec{F}}_{{m}_{1}} = - {\vec{F}}_{{m}_{2}} = [ - \frac{{Gm}^{2}}{{R}^{2}} + \frac{2 {m ( r ω )}^{2}}{R} ] \hat{Z} \qquad ( 1 )$$

$${lim}_{{M ≫ m}_{R ≫ r}} {\vec{F}}_{m} = - {\vec{F}}_{M} = [ - \frac{GMm}{{R}^{2}} + \frac{{m ( r ω )}^{2}}{R} ] \hat{Z} \qquad ( 2 )$$

FIG. 2

Sample of experimental data showing a decrease in effective weight in proportion to the rotational energy. Vacuum is achieved at approximately 400 seconds, and therefore fluid dynamics effects are not responsible for this weight reduction. See our attached paper (Evidence of Lift Force on Gyroscope) for more details.

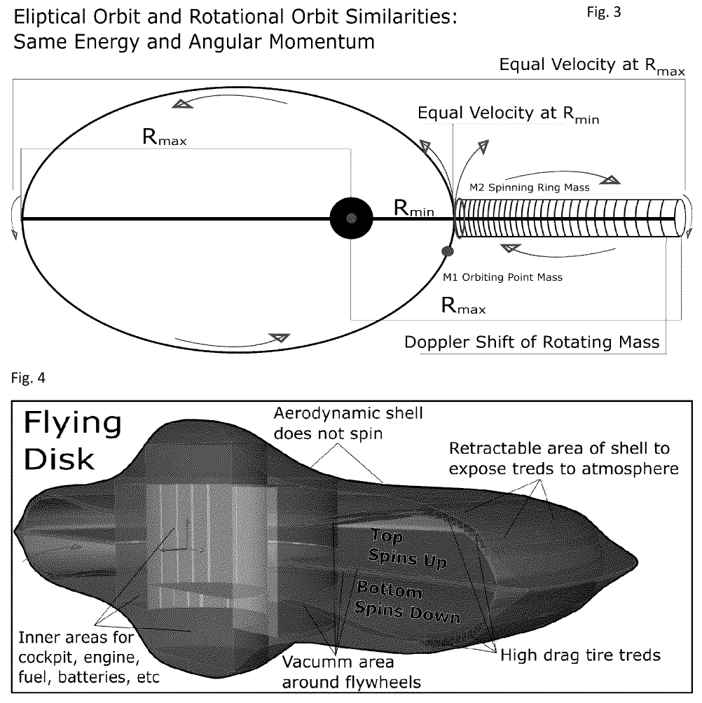

FIG. 3

With the right choice of coordinate systems, the equations of motion are equivalent. First we consider the elliptical orbit in polar coordinates. The equations for the force on the elliptical orbit in these coordinates is given by:

$$\vec{F} ( \vec{r} ) = m \ddot{\vec{r}} = m [ ( \ddot{r} - r {\dot{θ}}^{2} ) \hat{r} + ( \frac{1}{r} \frac{d ( {r}^{2} θ )}{dt} ) \hat{θ} ] ,$$

$$F ( r ) = - \frac{GMm}{{r}^{2}} = m ( \ddot{r} - r {\dot{θ}}^{2} ) ,$$

$$0 = \frac{1}{r} \frac{d ( {r}^{2} θ )}{dt}$$

Since there is no force acting along the angular direction, we know that the second term is equal to zero. This is equivalent to the conservation of angular momentum. Meanwhile, if we rearrange the force equation for the force along the radial direction, this gives exactly the same equation as (2):

$$m \ddot{r} = - \frac{GMm}{{r}^{2}} + \frac{{mr}^{2} {\dot{θ}}^{2}}{r} = - \frac{GMm}{{r}^{2}} + \frac{{( {mr}^{2} \dot{θ} )}^{2}}{{mr}^{3}} = - \frac{GMm}{{r}^{2}} + \frac{{L}_{1}^{2}}{{mr}^{3}} ,$$

$$where Angular Momentum \vert {L}_{1} \vert = {mr}^{2} \dot{θ}$$

Where the angular momentum is given by L. Compare that equation to the equation for motion of the spinning orbit, which is given by (2):

$$m \ddot{z} = - \frac{GMm}{{z}^{2}} + \frac{{m ( r ω )}^{2}}{z} = - \frac{GMm}{{z}^{2}} + \frac{{( {mzr}_{o} ω )}^{2}}{{mz}^{3}} = - \frac{GMm}{{z}^{2}} + \frac{{L}_{2}^{2}}{{mz}^{3}} ,$$

$$where Angular Momentum \vert {L}_{2} \vert = {mzr}_{o} ω$$

These equations are not just the same form, but are exactly the same as long as the elliptical orbit and the rotational orbit have the same initial conditions. In the figure above, consider the point at which the orbits are starting at the lowest altitude Rₘᵢₙ and the same initial speed Vₘₐₓ. At that point we can calculate the angular momentum and energy of the system:

$$Same initial conditions ,$$

$$r = {R}_{min} = z , r {\dot{θ}}_{o} = {V}_{max} = {r}_{o} {ω}_{o}$$

$$Same angular momentum ,$$

$$\vert {L}_{1} \vert = {mr}^{2} {\dot{θ}}_{o} = {mR}_{min} {V}_{max} = mz {r}_{o} {ω}_{o} = \vert {L}_{2} \vert$$

$$Same energy ,$$

$${E}_{1} = - \frac{GMm}{r} + \frac{1}{2} {m ( r {\dot{θ}}_{o} )}^{2} = \frac{GMm}{{R}_{min}} + \frac{1}{2} {m V}_{max}^{2} = \frac{GMm}{z} + \frac{1}{2} {m ( {r}_{o} {ω}_{o} )}^{2} = {E}_{2}$$

Therefore, both of these orbits have the exact same equations of motion for the coordinate that is equivalent to the distance from the center of dominant mass M.

### FIG. 4

Diagram of final craft with two oppositely rotating disks. To interact with the atmosphere through drag, there is a retractable area of the shell that allows for contact between the spinning disks and the atmosphere. Thrust is induced in one direction by exposing opposite sides of both disks to the atmosphere. The resultant drag acts like a drag racer's wheel on the asphalt.

1. A new mechanism for achieving levitation by using rotational energy is explained. This mechanism can be used to provide structural support for structures without adding additional weight to the structure (unlike a support column).

2. If there is a mechanism that allows for the flywheel to interact with the atmosphere (such as a small exposure) then the strong drag forces between the flywheel and the atmosphere can be used to generate a thrust in any direction coplanar with the flywheel.

3. To go up (or down) the craft would need to increase (or decrease) the total rotational velocities of both flywheels. This would transition the craft into an oscillating elliptical orbit in which it would either ascent or descent using the same orbital dynamics equations as a normal elliptical orbit.
